(19) United States
(12) Patent Application Publication
(10) Pub. No.: US 2013/0218795 A1
(43) Pub. Date: Aug. 22, 2013

(54) SYSTEM FOR CREATING AN ENTERTAINMENT NETWORK CONGLOMERATE VIA A GLOBAL COMPUTER NETWORK AND METHODS THEREOF

(71) Applicant: MICHEL RIENZO, Wood Ridge, NJ (US)

(72) Inventor: MICHEL RIENZO, Wood Ridge, NJ (US)

(21) Appl. No.: 13/772,045

(22) Filed: Feb. 20, 2013

Related U.S. Application Data
(60) Provisional application No. 61/600,932, filed on Feb. 20, 2012.

(51) Int. Cl. G06Q 10/10; G06Q 50/00

(52) U.S. Cl. CPC G06Q 10/1053; G06Q 50/01
USPC 705/321; 705/325

(57) ABSTRACT

A computer-implemented method for creating a network conglomerate system is provided. In exemplary embodiments, the method may comprise, at a computing device having one or more processors and memory storing one or more programs for execution by the one or more processors, receiving a request to create a user account from an entity; performing a security check to verify the identity of the entity; allowing the entity to enter general information about the entity if the identity of the entity is verified; receiving and storing the general information in a database and requesting specific information from the entity based on the general information entered by the entity; receiving and storing the specific information in the database enabling the network conglomerate system by generating and displaying a virtual tree based on the general information and the specific information, the tree comprising a virtual branch associated with at least one of a department and a skill.

### CROSS-REFERENCE TO RELATED APPLICATIONS

The present application claims priority to U.S. Provisional Patent Application Ser. No. 61/600,932 entitled “System for Creating an Entertainment Network Conglomerate via a Global Computer Network and Methods Thereof,” filed Feb. 20, 2012, the disclosure of which is incorporated herein by reference in its entirety.

### BACKGROUND

1. Field of the Invention

Embodiments of the present disclosure generally relate to a system for creating an entertainment network conglomerate via a global computer network and methods thereof. More specifically, embodiments of the present disclosure incorporate all types of entities into a database in order to facilitate their particular needs by providing a medium for exposure, increased business growth, employment opportunities, and the like, that will enable such entities to easily locate that which is essential to the entity's success and achieving goals in the entertainment industry.

2. Description of Related Art

In recent years, social networking websites have become increasingly popular. A typical social networking website enables individuals to “connect” with other friends and colleagues that access the website. Individuals using these websites may access content, such as text updates, photos, and videos, published by each of these “connections.” Social networking websites can be beneficial to individuals that desire to keep in touch with their connections because when used properly, each of the connections will provide current contact information. An additional benefit provided by social networking websites is that they allow for the sharing of information and opinions about certain products, services, and events.

Social networking websites can be ineffective, however, in helping individuals or businesses gain professional exposure, increased business growth, and find matches for employment opportunities. When a social networking user desires to search for a job, for example, their options may be limited to directly contacting individuals within their contents, without the knowledge of the existence of a specific job opening. If the individuals contacted are unaware of any job openings that may fit what the user is looking for, the search reaches a dead-end. Similarly, social networking websites can also be ineffective for employers looking to hire individuals. When an employer searches a social networking website for job candidates, the employer must actively search through profiles containing limited relevant information, which can be time consuming and ineffective.

Social networking websites are also limited in their functionality within the fields of entertainment and education. Representatives of an educational institution, for example, cannot effectively use social networking websites to identify candidates. Social networking websites lack the capability to actively identify users that possess attributes desired by an educational program. Similarly, entertainment groups, such as music bands, sports teams, or comedy venues, are also unable to match up and connect with potential members of the group. Students and entertainers also cannot effectively use social networking websites to find potential educational institutions or entertainment groups that may be a match for them. Social networking websites are also limited in that they do not allow users to view a visual representation of their networks and the capabilities of their contacts, or form an entertainment or educational network conglomerate.

Thus, there is a need for a system for creating a network conglomerate via a global computer network and methods thereof.

### SUMMARY

Embodiments of the present disclosure generally relate to a system for creating an entertainment network conglomerate via a global computer network and methods thereof. In one embodiment, a computer-implemented method for creating a network conglomerate system is provided that may comprise, at a computing device having one or more processors and memory storing one or more programs for execution by the one or more processors, receiving a request to create a user account from an entity; performing a security check to verify the identity of the entity; allowing the entity to enter general information about the entity if the identity of the entity is verified; receiving and storing the general information in a database and requesting specific information from the entity based on the general information entered by the entity; receiving and storing the specific information in the database; and enabling the network conglomerate system by generating and displaying a virtual tree based on the general information and the specific information, the tree comprising a virtual branch associated with at least one of a department and a skill.

In another embodiment of the present disclosure, a computer-implemented method for creating a network conglomerate system is provided that may comprise, at a computing device having one or more processors and memory storing one or more programs for execution by the one or more processors, receiving a request to create a user account from an organization; receiving information about the organization; performing a security check to verify the identity of the organization; issuing a virtual seed to the organization if the identity of the organization is verified and the information complies with a set of requirements, the seed comprising a certification the organization is approved to use the network conglomerate system; generating a virtual trunk for the organization if a seed has been issued; allowing the organization to add virtual branches to the virtual trunk, each of the virtual branches representing a department of the organization; allowing the organization to add one or more virtual leaves to the virtual branches, each of the virtual leaves associated with a representative of each department of the organization; and generating and displaying a virtual tree, the virtual tree comprising the virtual trunk, the virtual branches, and the virtual leaves.

In yet another embodiment of the present disclosure, a computer-implemented method for creating a network conglomerate system is provided that may comprise, at a computing device having one or more processors and memory storing one or more programs for execution by the one or more processors, receiving a request to create a user account from an individual; performing a security check to verify the identity of the individual; allowing the individual to enter general information about the individual if the identity of the individual is verified; receiving and storing the general information in a database and requesting specific information from the individual based on the general information; receiving and storing the specific information in a database; and enabling the network conglomerate system by generating and displaying a virtual tree based on the general information and the specific information, the tree comprising a virtual branch associated with a skill and leaves associated with one or more branches, the leaves representing joint ventures the individual is associated with.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of a system for creating an entertainment network conglomerate via a global computer network in accordance with one embodiment of the present invention;

FIG. 2 depicts a block diagram of a general computer system in accordance with one embodiment of the present disclosure;

FIG. 3 depicts a block diagram of a tree system in accordance with embodiments of the present disclosure;

FIG. 4 depicts a block diagram of a graphical user interface in accordance with embodiments of the present disclosure;

FIG. 5 depicts an exemplary virtual tree in accordance with embodiments of the present disclosure;

FIG. 6 depicts a flowchart of a method of creating an entertainment network conglomerate via a global computer network in accordance with exemplary embodiments of the present disclosure; and

FIG. 7 depicts a flowchart of a method of creating an entertainment network conglomerate via a global computer network in accordance with exemplary embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to system for creating an entertainment network conglomerate via a global computer network and methods thereof. More specifically, embodiments of the present invention incorporate all types of entities into a database in order to facilitate their particular needs by providing a medium for exposure, increased business growth, employment opportunities, and the like, that will enable such entities to easily locate that which is essential to the entity's success and achieving goals in the entertainment industry.

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

As used herein, the term “multimedia data” refers to any type of data that may reasonably be construed as a media data type, including specifically, audio data (e.g., sound bites, music, or the like), visual data (e.g., photographs, images, graphics, videos, or the like), text data (e.g., as entered by a user from an input device or generated by a computing device), digital files, barcode data (e.g., as commonly found on tickets, labels, or the like), radio frequency identification (RFID) data, Quick Response (QR) tags, geographic and/or directional data (e.g., as reported from a Global Positioning System (GPS), a mobile communications system, or a preprogrammed routing source, often in the form of coordinates, or relationship positioning), or the like. As understood by the embodiments disclosed herein, any discussion of one particular form of multimedia data or data, shall be inclusive of any other type of multimedia data as defined above.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

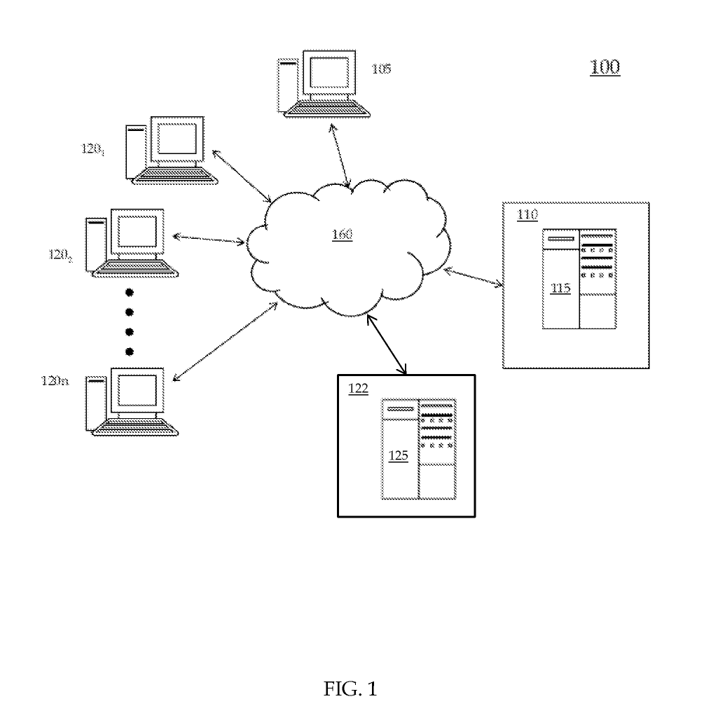

FIG. 1 depicts a system-level network diagram of a computer system for creating an entertainment network conglomerate via a global computer network in accordance with one embodiment of the present invention. The computer system 100 generally comprises at least a first user 105 and secondary users 120₁ and 120₂, each in communication with an administrator 110, generally hosting a central server 115 or database, through a network 160, which may comprise a global computer network, for example, the Internet.

As is common in network-based business models, the administrator 110 may also comprise a web administrator, responsible for providing and maintaining a website or interactive portal through which all of the users of the computer system 100 may interact and execute the methodology and functionality disclosed in the embodiments disclosed herein.

Although FIG. 1 explicitly depicts three secondary users 120₁, 120₂, and 120ₙ, it should be appreciated that “n” represents any number of users feasible in accordance with embodiments of the present disclosure. For ease of reference, as used herein, each of the terms “second user” or “secondary user” may refer to any one or all of the users 120₁, 120₂, and 120ₙ within the computer system 100. Likewise, although FIG. 1 explicitly depicts only one first user 105, there may be more than one first user 105 in accordance with certain embodiments of the present disclosure. That is, in certain embodiments, multiple users may perform the same or similar functions as the first user 105. As understood by embodiments of the present disclosure, a user may include any person, business, organization, group, or other entity, capable of participating in the system and methods disclosed herein.

The first user 105 generally has an affiliation or interest in some form of entertainment, such as acting, sports, comedy, music, arts, writing, or the like. In alternative embodiments, the user 105 may have an affiliation or interest in education, business, networking, professional development, and/or the like. In many embodiments, the first user 105 generally comprises an individual, a business, an institution, and/or an educational facility. The secondary users 120 may also possess any of the plausible same or similar intents as the first user 105.

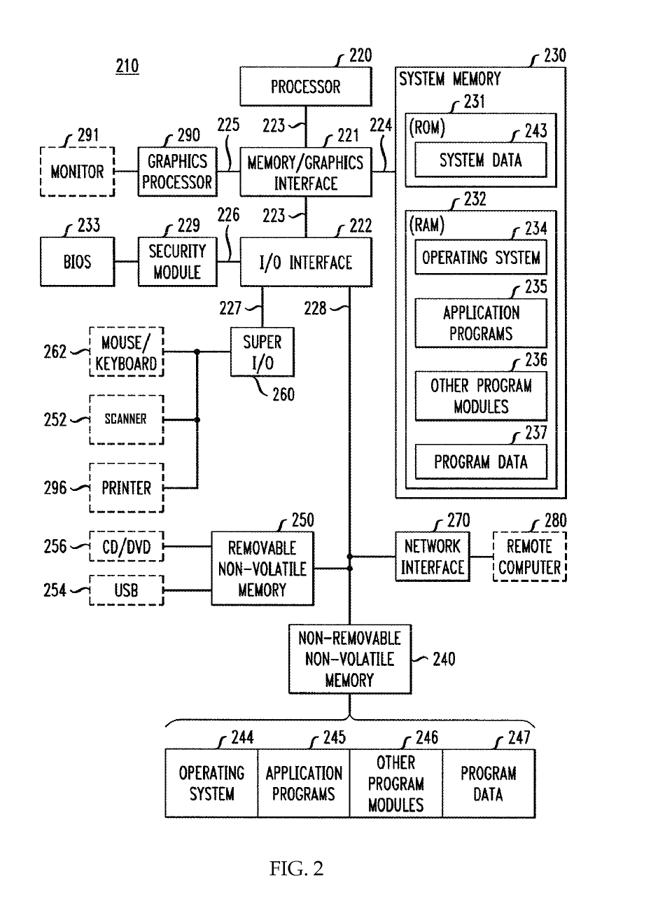

In a basic exemplary embodiment, within the computer system 100, a first user 105 may be capable of transmitting data to the administrator 110, using a computing device. The computing device in the context of this application may include, but is not limited to a mobile device, a personal computer, a desktop computer, a smartphone, an Apple iPhone, a Blackberry device, Personal Data Assistant (PDA), a netbook, a mobile computer or the like, or may generally include a general purpose computer, or components thereof as discussed below in FIG. 2.

As explained above, the network 160 may comprise any network suitable for embodiments of the present disclosure. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G, 4G, and 5G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

Optionally, a third party 122, generally hosting a server 125, database, non-commercial server, or the like, may be in communication with the computer system 100 through the network 160 to carry out certain features of embodiments of the present disclosure, as explained below. In accordance with embodiments of the present disclosure, such third party servers 125 may be administered by financial institutions (e.g., banks, credit card companies, or the like), advertisers (e.g., any third party offering banner ads or displayed offers), local merchants (e.g., providing information regarding an area or services within an area) social networking sites (e.g., Facebook, MySpace, Twitter, FourSquare or the like), global positioning system administrators, or the like.

In accordance with one embodiment of the present disclosure, any of the administrator or users may comprise a general purpose computer, for example, as shown in the form of a computer 210 depicted in FIG. 2. As appreciated by embodiments of the present disclosure, more practical devices, such as mobile devices, mobile telephones, laptop computers, netbooks, tablet computers, or the like, are likely to be utilized than a general computer 210 for embodiments of the present disclosure. However, it is also appreciated there is a significant similarly in core components between a mobile device, a personal computer, and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of peripherals, such as scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, touch screen, fax machine, modem, touch pad, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present disclosure, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure. Further, but other commonly known, components for mobile devices and personal computers may also be included in a general computer 210. For example, global positioning chips, wireless communication capability, and related technologies should be included within many embodiments of the present disclosure.

It is understood by embodiments of the present disclosure that a computer, such as the one depicted in FIG. 2, may be connected to a computer network or system. A computer network may include the Internet, a global computer network, a global positioning system, an internal computer network, dedicated server networks, or the like.

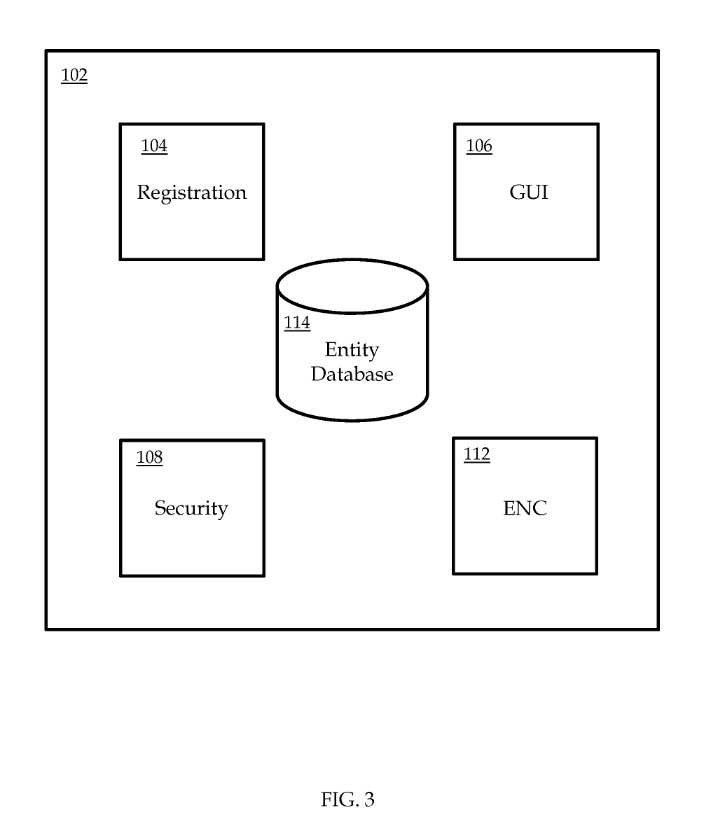

FIG. 3 depicts a block diagram of a tree system 102 in accordance with embodiments of the present disclosure. The tree system 102 may generally comprise computer executable software and/or instructions configured to perform the functionality of the systems and methods disclosed herein. The tree system 102 may comprise a registration module 104, a graphical user interface (“GUI”) module 106, a security module 108, a entertainment network conglomerate (“ENC”) module 112, and an entity database 114. In exemplary embodiments, the tree system 102 may comprise a system of organizing, managing, and maintaining an ENC in accordance with embodiments of the present disclosure. The tree system 102 may be adapted to encourage entities within the tree system 102 to help their “tree” grow, prosper, and yield maximized results.

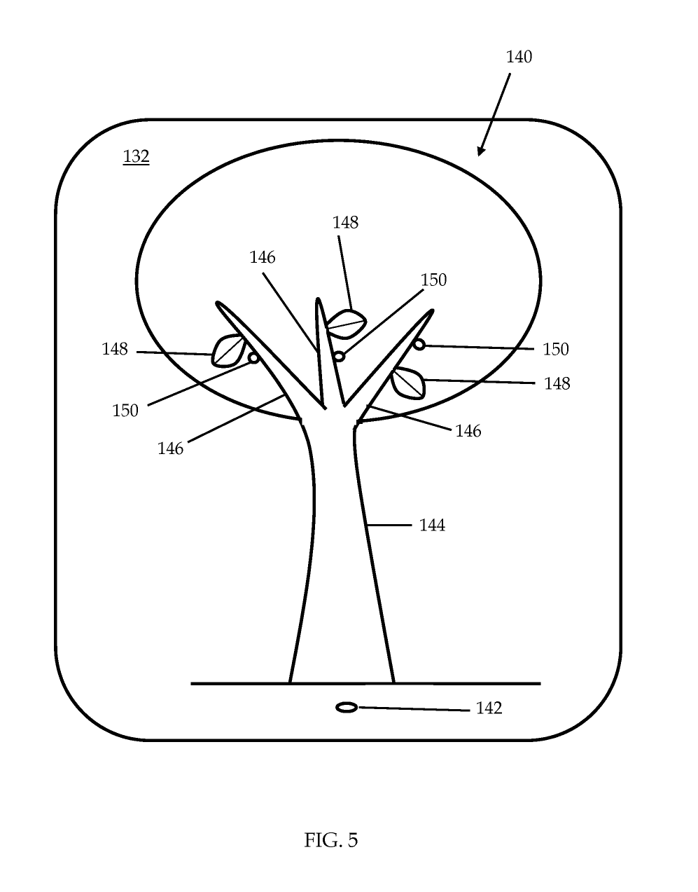

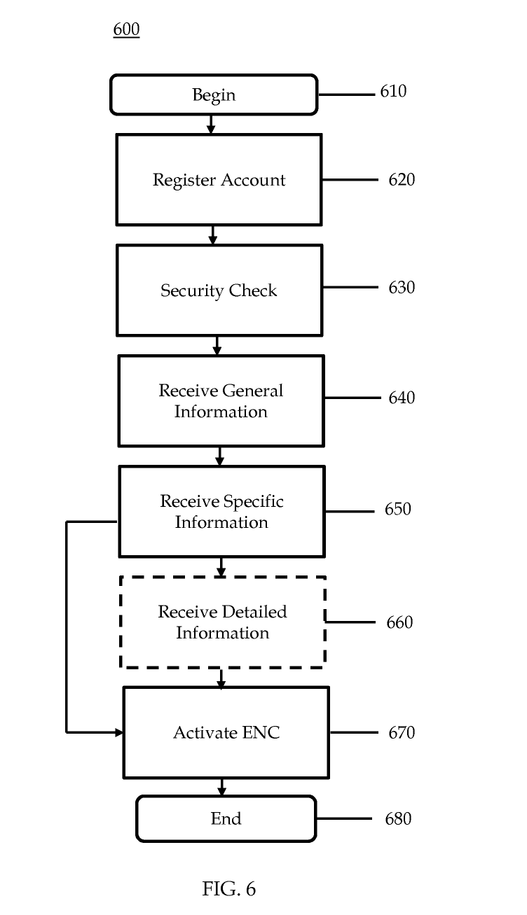

The GUI module 106 may be adapted to generate a graphical representation of the data received, stored, and/or manipulated by the tree system 102, such that elements of the tree system 102 may be displayed on a computing device, or the like. In exemplary embodiments, a GUI may be adapted to display a graphical representation of an ENC. The GUI may also be adapted to enable a user to enter data, control functionality of the system 102, and manipulate the tree system 102 and data stored within the system 102. The GUI may comprise a look and feel that is comfortable for the user and user-friendly. The appearance and functionality of the GUI may generally be configured by an administrator or may be preconfigured. An example of a GUI may be seen with respect to FIGS. 5 and 6, described below.

In order to access the system 102, in some embodiments, the security module 108 may require an entity to pass a security check to insure identity of the entity. In many embodiments, such security may be confirmed via the manual entry of certain security data, such as personal data (e.g., EINs, SSNs, etc.), the confirmation of certain data provided on third party reports (e.g., credit reports, Dun & Bradstreet listings, etc.), via payment of a fee (e.g., using a credit card owned by such entity), entry of a password mailed to an entity, a retinal scan, a fingerprint scan, or the like. In further embodiments, the security module 108 may be adapted to implement more comprehensive security measures, such as face-to-face confirmation or use of third party security agency, may be utilized as well.

The registration module 104 may be adapted to receive the registration of an entity for a user account or a “Springlinc” account. Springlinc accounts may be granted access to the system 102 and may comprise different types of accounts. For example, a Springlinc account may be adapted for use by specific types of entities. An entity may comprise an individual, a business, an institution, an educational facility, or any user granted access to the system 102. In addition to type of entity, different Springlinc accounts with different capabilities and/or security permissions may be generated by the registration module 104 in response to information received from an entity. The registration module 104 may generally be adapted to allow an entity to register for an account by providing information regarding the nature of the entity and/or specific information about the entity. For example, the system 102 may be adapted to allow an entity to select a type of account based upon whether the entity is an individual, a business, an institution, an educational facility, and/or the like.

The registration module 104 may also be adapted to generate Springlinc accounts with different capabilities within the same entity type. For example, an entity may comprise different individual users with different roles and responsibilities, such as administrators, security personnel, hiring managers, department heads, team leaders, and/or the like. The registration module 104 may also be adapted to provide an entity questions and receive answers to the questions. The registration module 104 may also be configured to store data related to the entities, whether provided by an entity or generated by the system 102, in an entity database 114 or other sortable data storage memory adapted to enable the systems and methods disclosed herein.

The entity database 114 may be any data storage database suitable for embodiments of the present disclosure. For example, in one embodiment, the entity database 114 may comprise at least one or more database management systems, such as any of an Oracle, DB2, Microsoft Access, Microsoft SQL Server, Postgres, MySQL, 4th Dimension, FileMaker, Alpha Five Database Management System, or the like. Data stored in the entity database 114 may generally be accessed by any module described herein. In some embodiments, each module may be configured with specific security permissions, for example, read, write, execute, delete, and/or the like.

The entity database 114 may be adapted to store data received by the registration module 104. The registration module 104 may be adapted to receive general information about the entity, and its purpose of joining the system is provided. For example, such generally information may be received in response to inquiries, such as “what is the purpose of activating your account,” or similar inquires. The entity may be able to freely provide an answer, or may have to select from predetermined choices, such as “employment, exposure, searching for new talent, just a fan,” or the like.

The registration module 104 may also be adapted to receive more detailed information regarding an entity. For example, detailed information may include: whether such entity is a performer, athlete, or other profession, or possesses a specific talent; multiple talents (e.g., actor and stand-up comedian); common questions regarding the entity's personal make-up (e.g., gender, age, height, weight, eye color, hair color, languages, area where residing, race, education level or the like); and follow up inquiries. The follow-up inquiries may be based on answers to information provided by the entity. For example, if the individual is an actor/actress, information may be sought regarding experience, any special skills/talents, any disabilities, the entity's willingness to travel, etc. In another example, if the individual is a comedian, information may be sought regarding the type of comedy, years of experience, type of training-formal, self-taught, experience (e.g., live performances, television, etc.), the nature of the material (e.g., original, use of writers, etc.).

The registration module 104 may also be adapted to collect data from other account types, for example, athletes, musicians, authors, other professions, or the like. In some embodiments, certain individuals may belong to multiple account types, for example, an entity may be an athlete and an author. The registration module may be adapted to incorporate all of the entities information into one area, for example, one area of a virtual “Tree Trunk.” In exemplary embodiments, the registration module 104 may be adapted to allow the user to submit answers to questions of various levels of detail, examples of which are described below with respect to FIG. 6.

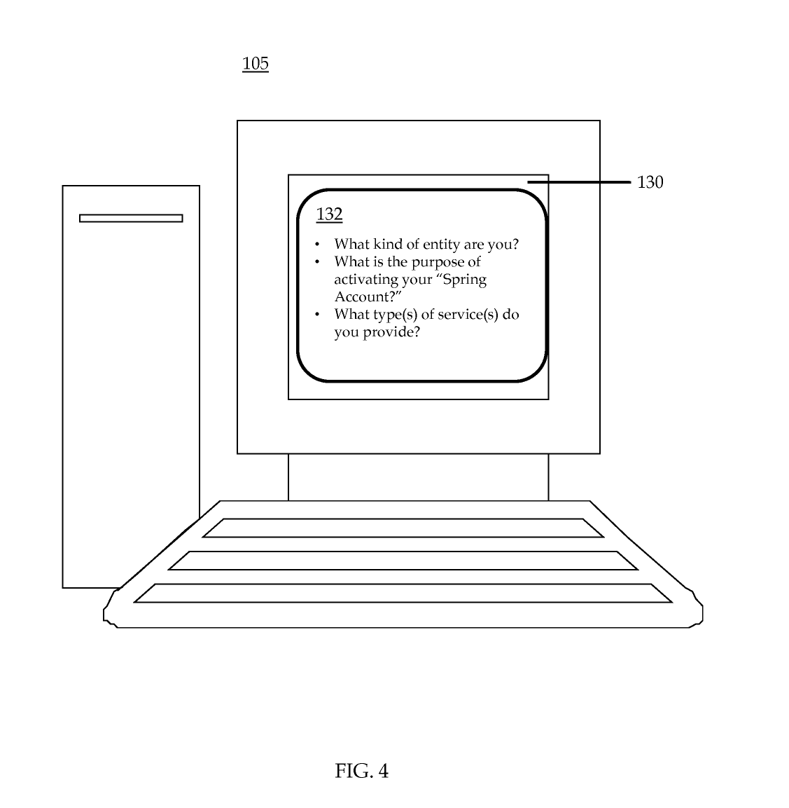

The ENC Module 112 may be adapted to enable the ENC. Various types of ENC's may be formed within the system, as various entities in different areas of entertainment may form different types of synergistic relationships with other entities. The system 102 may be adapted to allow an entity with a Springlinc account generated by the registration module 104 to access an ENC displayed via a GUI generated by the GUI Module 106. In many embodiments, the tree system 102 may comprise various levels of a stored or graphically generated tree that may include seeds, trunks, branches, leaves and pods. In exemplary embodiments, a user may request to access the tree system 102 by submitting a request to activate a Springlinc account to a second user. The second user may comprise an administrator or a user assigned sufficient security rights to activate accounts within the tree system 102. When an account is activated, a “seed” is formed, and may be graphically represented in a GUI and displayed to a user of a Springlinc account. After a seed is formed, a tree trunk may be established, wherein the tree trunk is a logical or graphical representation of an entity that may be stored, manipulated, and/or displayed by the tree system 102. In some embodiments, the tree system 102 may be adapted to allow a user, such as an administrator, to select various entity departments and form “branches.” The branches may comprise logical or graphical representations of departments that may be logically and/or graphcially connected the tree trunk and displayed to the user via a GUI. The GUI may be generated by the GUI module 106 and may be displayed on a computing device in accordance with embodiments of the present disclosure, as depicted in FIG. 4.

FIG. 4 depicts a block diagram of a GUI 132 displayed on a display 130 in accordance with embodiments of the present disclosure. The GUI 132 may generally be adapted to provide the user with a portal to access any system in accordance with the present disclosure, and view information generated by the system on the display 130 of a user 105. The display 130 may comprise two dimensional display, a three dimensional display, a touch screen display, a display that provides haptic feedback, a four dimensional display, a plasma display, a liquid crystal display, or the like. The user 105 may comprise any entity in accordance with embodiments of the present disclosure.

The GUI 132 may be adapted to display queries to the user in connection with the user registration process, to allow an entity to interact with the tree system 102. For example, the GUI 132 may display queries, such as those depicted in FIG. 4, or any inquiry in accordance with the present disclosure, or the like. The GUI 132 may be also adapted to enable an entity to submit data, receive data from an entity, and send data to other entities or Springlinc accounts through use of the system 102. The GUI 132 may be adapted to be user friendly, and to comprise customizable menus to allow the user to manipulate the look and feel of the display of data and images generated by the system 102. In addition, the GUI 132 may be adapted to allow a user to run reports, print elements generated by the GUI module, and/or interact with other Springlinc users through direct messages, message boards, text chats, video chats, instant messaging, blogs, user generated feeds, or the like. The GUI 132 may also be adapted to display a graphical representation of an ENC comprising a tree. By way of example, the tree may be a graphic representation similar to the tree depicted in FIG. 5. Although depicted in FIG. 5 as a graphical representation of an actual tree, a hierarchical organizational tree comprising lines, or another hierarchical structure in accordance with embodiments of the present disclosure may be generated and displayed.

FIG. 5 depicts an exemplary virtual tree 140 displayed via a GUI 132 in accordance with embodiments of the present disclosure. The tree 140 may generally comprise a graphical representation of an ENC in accordance with embodiments of the present disclosure. The tree 140 may comprise representations of one or more seeds 142, trunks 144, branches 146, leaves 148, and/or pods 150 displayed on a display, generated, and/or stored by the tree system. In many embodiments, Springlinc accounts may function based around a “branch” system coinciding with the tree system. Trees 140 may be generated by the tree system based on parameters received by an entity and authorized by the tree system or a representative of the entity. In order to generate a tree 140, a user, such as an administrator, may authorize the activation of a Springlinc account, thus forming the seed 142. The branches 146 may then be selected by via the Springlinc account.

The branches 146 may generally comprise graphical representations of departments and/or skill sets. Leaves 148 may generally comprise graphical representations of representatives of each department represented by the branches 146. The representatives of each department may be selected by an administrator or an entity by accessing the tree system. In some embodiments, the tree system may be adapted to allow a system administrator to configure some or all functionality of the system and manipulate data saved in an entity database. As a leaf 148, an individual may assume control/responsibility over the department and its affiliates of communicating with users that may interact with the leaf's 148 branch 146. For example, the leaves 148 may communicate with potential members of the branch 150. Individuals in the “leaf” position may also be able to create, promote, update and edit their branch 146 representing that specific department.

When creating a Springlinc account, a leaf 148 or branch 146 leader may answer specific questions regarding the requirements for each respective field of the acting department. For example, a department leader in an educational insitution may be presented questions regarding GPA, portfolio work, and special skills will enable eligible students to find that particular institution and for the institution to view students who qualify for enrollment. In another example, a leaf 148 may present employment opportunities within the branch 148 and follow a similar pattern of questioning in order to find the most qualified candidates to fill the position(s) being offered.

As used throughout this disclosure, there is a description of a “tree” system, having various components which make up embodiments of the present invention. The following summary of the “tree” system is intended to shed light on various exemplary structures of some embodiments of the present invention, but should not be considered limiting to equally identifiable structures. In many embodiments, the tree system serves as a purpose for security, account management and structure, and a sense of “imagery” that will motivate account holders to continually build/develop their profile and watch it grow.

Security-Educational Institutions:

For the assurance in protecting the privacy/integrity of business institutions and private individuals, each entity may be required to pass a series of checkpoints in order to establish legitimacy. Once an educational institution has been confirmed to legitimate, the school will be issued a seed 142. As in nature, the seed 142 serves as the inception for a tree 140. On a tree system and or Springlinc website or other portal, the seed 142 may serve as the base or beginning of an account. With access to a seed 142, the school's administrator, who may be a person in charge of the a Springlinc account for an entity, can begin growing the tree 140, which will lead to branches 146 (that may comprise departments) and leaves 148 (that may comprise department heads/representatives). During the construction of the tree 140, administrators may be provided the power and security permissions to disable their tree 140 for temporary maintenance, additions/removals, or permanent disengagement.

Responsibilities of a “Leaf”:

For educational institutions, the number of branches 146 may be substantilly unlimited. Once a branch 146 is created, administrators may chose leaves 148 to represent that particular branch 146 (which may comprise the faculty, coaches, secretaries, etc. of a department). As a leaf 148, the selected individual may be provided a certain amount of authority and responsibility by the system. Certain responsibilities may include: (1) General Manager (i.e., Leader of the Branch: oversees all branch activity, authority; authority to add/remove leaves 148; accept/decline student applicants; add/remove any materials previously approved or rejected currently); (2) Secretary (i.e., secretarial positions could be filled by multiple people who have various tasks to fill, such as: paperwork, student affairs, communications representatives, appointment scheduling, questions/issues regarding departments, and secretaries may also handle job applications/employment applications); (3) Teacher (i.e., teachers selected to become leaves 148 would have the authority to conduct specific searches for students or assistants so as to promote the school and/or specific department, and the teachers are generally the biggest asset to the branch 146; (4) Athletic Coaches (i.e., the authority and responsibility of any coach are similar to those duties carried out by teachers, and a coach can: conduct a search for an athlete, view submitted profiles, communicate and meet with athletes, and ultimately submit an athlete's applications for approval by the General Manager); (5) Account Managers (i.e., account managers responsibility is creativity, and their job is to build the branch dealing with: content, layout, images, videos, other facets of creativity in order to obtain a high level of “eye” appeal for prospective students and/or employees); and (6) Student Representatives (i.e., student reps are members of a particular department who have been selected to best represent “student life,” and these particular students must reach certain department requirements such as: GPA, amount of involvement with the school, grade level, activity within a specific department, other specifics that assist superior students start above the rest, and the goal of the student reps is to show what they have accomplished in school and form a bond with prospective students who share similar interests). By allowing prospective students to form a connection with student reps, the system may enable to enable prospective students to obtain a perspective of the school seen through the eyes of a current student.

It should be noted, the responsibility of Teachers in the tree system may include: (i) accurately describing the school's/department's strengths via video descriptions of the school and respect dept., virtual reality tours, listing of achievements, notable alumni/professors, etc.; (ii) select prospective students who will then be under review for the General Manager's approval; and (iii) ability to create a bridge of direct communication between potential students and themselves allowing the exchange of information, account assistance, etc. In exemplary emboidments, the tree system may permit verbal communication between teachers and students. Such communication may help foster a “personal” aspect, which in turn will further help students become more attracted and comfortable with the school before ever attending; and this will also help minimize the “home sick” feeling of many first year students being away from home

POD(s)

In exemplary embodiments, a pod 150 may comprise an entity that has been approved by a leaf 148 of a branch 146 for potential involvement with the branch 146. For example, students, athletes, and potential employees who have been approved by a leaf 148 (e.g., a manager, general manager, coach, team leader, department chair, department head, or the like) of a branch 146 may be designated as a “pod” 150. Becoming a pod 150 may provide recognition to an entity, such as an individual, who has attained the requirements for a job, sports team, or the like, or gained acceptance into a program. As a designated pod 150, the system may be adapted to allow the selected individual to become eligible for admittance into the field of inquiry. The pods 150 may be graphically represented by the GUI 132 as being grouped together. In some embodiments, the pods 150 may be graphically represented by the GUI 132 as being attached to the branch 146 to which the pods 150 have gained approval. The pods 150 may be placed into various pools that represent their respective fields. A user, administrator, leaf 148, or the like may be have access to each pool, or collection of pods 150, where they may manually accept who they wish to employ, or enroll into the school system, or the like.

The “Tree” System in Business.

The functions of the tree system for businesses may generally be similar to the functions of the tree system for educational institutions. Each business, upon approval, may receive a seed 142. Once a seed 142 is granted, a representative of the business and/or business owner may be issued a tree trunk 144 enabling them to manually create branches 146 that may represent designated areas of the business. For example, branches 146 may be represented by: awards, citations, company history, customer ratings, images, retail/services, reviews, videos, reviews, or the like.

The use and functionality of leaves 148 may be dependent upon the Business Administrator of the tree 140. Some businesses may require an entire fleet of leaves 148 while others may have no use for them. Some examples of potential business leaves 148 are: accountants, attorneys, managers, sales reps, secretaries, or other employees that are chosen to represent or manage a particular branch 146, or the like.

Similar to the administrators of an education institution, business owners may be provided complete control over their entity's branches 146 and leaves 148. They may have the ability to manage the company tree 140 according to any manner they believe is necessary to the company's prosperity and growth. When a business owner employs the use of pods 150, the functionality of the bods 150 may be similar to those used when an education administrator accesses the system. Pods 150 may be given to individuals who have been accepted by administration for the purpose they have applied for. Once the pods 150 have been submitted into their categories, administration will then have the ability to choose whom or what they want.

The “Tree” System for Individuals.

The purpose of the tree system for the individual may be to help promote and display all of the facets that make up the individual and what they have to offer. The tree system may be adapted to comprise branches 146 that are made to serve as the areas that are created and customized to the specific needs and desires of the particular individual. For example, branches 146 may represent archives, blogs, pictures, portfolio work, videos and other ideas that best represent the individual and what they have to offer.

Leaves 148 in the individual profile may generally be optional, but may be useful in the terms of joint ventures such as: bands, comedy teams, dance teams, ensembles, or the like. Pods 150 may generally be option as well, but may potentially comprise an addition needed to form, for example, an acting team, magic show, rock group, entertainment group, or the like.

“Account Holders”

An “Account Holder” may be granted access to the tree system and may generally comprise individuals, schools, business or any other entity. The account holders may join their accounts in specific areas designated as nests (not shown). Nests may be used to represent an area of affairs, where two equal parties share a mutual interest. For example, the system may be adapted to allow members of a rock band may equally form a “nest,” which would show other users the connection between the members of the group who will be able to add information to the “nest” equally. Information for each individual member will remain separate from the information stored in the “nest” in order to preserve the idea of individualism.

Companies that share mutual interests such as: ideas, people, products, sponsors, or the like, could form a link between the companies by forming a nest and channeling the information relevant to both entities. Educational Institutions may use nests as a method of connecting with other schools that are relevant to each other. Nests may be formed for: awareness programs, entertainment events, extra-curricular activities, fund-raising, sponsors, sporting events, etc. In general, the tree system may allow Nests to be edited by any of the mutually-involved parties or disassembled when parties decide to exit the nest. In summary, when using the “tree system,” the larger the effort the entity puts in the more the tree will grow and become strong. The leaves may be adapted to serve a dual purpose: Visual and Symbolic; Visual when viewing account “trees”—i.e., the more the tree is viewed, the more “leafs” are added to the tree, and Symbolic because of the people of significance within a “branch.”

In exemplary embodiments, the system may comprise searching capabilities allowing an entity to search portions of the system. For example, the system may be adapted to provide a search GUI, search menu, or the like, that may allow an entity to search, browse, sort, and/or filter data stored in an entity database. In some embodiments, numerous searching efforts may be conducted within the system in order to effectuate various embodiments of the present invention. In accordance with one exemplary embodiment, the searching methods for the system may be described as follows, although alternative and variations hereof are well within the scope of other embodiments.

In exemplary embodiments, conducting a customized search within the system may comprise five components that are applicable to the three major areas involving individual(s), business, and education. Alternative numbers of components and areas are contemplated by and within embodiments of the present disclosure. A primary purpose of these components may be to help better prioritize searches and make them more precise and less generic or broad. Each of these five components can be customized in order to best suit the needs of the user, which also includes the exclusion of any of the components that are useless to the particular search or using them multiple times where necessary. In the example provided, the components include: Imperative, Secondary, Optional, Range, and Imperative Range.

The imperative precedent is applied to questions, requests, or requirements that are more or less necessary for the particular position of inquiry. For example, for an individual, a talent scout seeking a Caucasian (imperative) male (imperative) amputee (imperative) missing a left limb (imperative). In another example, for a business, record label seeking an individual with a degree in Sound Engineering (imperative). In a further example, for an educational institution, an ivy league school seeking a male (imperative) quarterback (imperative) with an overall GPA of 4.0 (imperative). These examples show what traits could potentially serve as prerequisites required by the searcher.

The secondary precedent can be used to help identify a potential candidate that possesses at least one of the few traits desired. For example, for an individual, a musician seeking a Caucasian male who plays lead OR bass guitar. In another example, for a business, a comedy club seeking a male prop comic OR standup comic. In a further example, for an educational institution, a college football program seeking a head coach with professional OR NCAA credentials. It should be noted that the traits placed between “OR” are meant to show that in those particular cases, either of those traits would suffice for the position without either holding precedence over the other. Generally, another facet of the “Secondary” category is that the number of subsequent traits is limited in order to highlight the top few requests of the searcher.

The optional precedent allows for certain traits, qualifications, and skills to be placed in a very broad or generic area with no restrictions since it contains minute relevance regarding the search. For example, for an individual, a talent scout allowing the eye color of talent to be “optional.” In another example, for a business, a publishing house seeking new novelists enabling submission of novel types to be “Optional.” In a further example, for educational institutions, an acting department seeking new actors whose backgrounds (stage/screen; dramatic/comedic, etc.) are all “Optional.”

The range precedent permits searchers to create a certain radius or guideline (cutoff) that may involve distance, size, and numerical criteria. For example, for an individual, a talent scout seeking a male between 5′7 and 6′1. In another example, for a business, a night club seeking a Jazz band 50-100 miles from the club. In a further example, for an educational institution, a college seeking all prospective students considered for enrollment to have a GPA between 3.5 and 4.0.

The imperative range is similar to “Range” with the only differing factor being the level of importance. With imperative range, requirements in this category can be met in order for any potential candidates to appear on the list of results up for consideration. If a person's height/weight, business' distance, or school's GPA requirement does not fall in the “imperative range”, the candidates will not be qualified to appear in the results.

In many embodiments utilizing the searching capabilities of the system, for organizing matches, candidates will be listed based on a scale of most to least regarding the five components. For example, imperative, range imperative, secondary, range, optional. In such an example, the imperative component may be deemed most important with optional being least. The more imperatives and secondary traits a candidate contains, the closer they will be to the top results.

FIG. 6 depicts a flowchart of a method of creating an entertainment network conglomerate via a global computer network in accordance with exemplary embodiments of the present disclosure. As utilized in method 600 disclosed herein, a “tree system” of organizing an entertainment network conglomerate in accordance with embodiments of the present invention is described. In accordance with one embodiment of the present invention, a tree system is a highly beneficial, creative and efficient method of managing and maintaining a entertainment network conglomerate. As the growing of a tree is a theme of the Spring season, the system(s) disclosed herein encourage all of the entities within the system to help their “tree” grow and prosper so the system can yield maximized results.

The method 600 begins at step 610. At step 620, an entity (for example, the first user) creates an account. Generally, such step includes the selection of the nature of the entity. That is, the entity may have to open a user account based on whether the entity is an individual, a business, an institution or an educational facility.

At step 630, a security check may be provided. In one embodiment, for businesses, institutions and individuals, a security check may be performed to insure identity of the entity. In many embodiments, such security may be confirmed via the manual entry of certain security data, such as personal data (e.g., EINs, SSNs, etc.), the confirmation of certain data provided on third party reports (e.g., credit reports, Dun & Bradstreet listings, etc.), via payment of a fee (e.g., using a credit card owned by such entity) or the like. In further embodiments, more comprehensive security measures, such as face-to-face confirmation, retina scans, fingerprint scans, key fobs, tokens, multi-factor authentication, or use of third party security agency, may be utilized as well. Face-to-face confirmation may be conducted in-person or via video conferencing technology.

At step 640, some general information about the entity, and its purpose of joining the system is provided. For example, such generally information may be in the form of inquiries, such as “what is the purpose of activating your account?” The entity may be able to freely provide an answer, or may have to select from predetermined choices, such as “employment, exposure, searching for new talent, just a fan” or the like.

At step 650, specific information about the entity may be provided and/or stored. Where the entity comprises an individual, which may be a majority of the entities, such entity may provide specific information about him- or herself. For example, such information may include: whether such entity is a performer, athlete, or other; multiple talents (e.g., actor and stand-up comedian), common questions regarding the entity's personal make-up (e.g., gender, age, height, weight, eye color, hair color, languages, area where residing, race, education level or the like)

Such step may also include further specific inquiries once a baseline is established. For example, if the individual is an actor/actress, information may be sought regarding experience (e.g., Broadway, off-Broadway, commercials, television, etc.), any special skills/talents (e.g., accents, instrument playing, fencing, motorcycle riding, parachute jumping), any disabilities, the entity's willingness to travel, etc. In another example, if the individual is a comedian, information may be sought regarding the type of comedy, years of experience, type of training-formal, self-taught, experience (e.g., live performances, television, etc.), the nature of the material (e.g., original, use of writers, etc.).

In another example, if the individual is an athlete, information may be sought regarding gender, age, height, weight, sports and positions played, years of experience (e.g., pre-high school, high school, college, semi-pro/professional), accolades (e.g., achievements, awards, records, trophies, etc.), reasons for joining the system (e.g., seeking a college scholarship, land a position on a professional team, etc.), academic information (e.g., GPA and SAT scores), third party assessments (e.g., letters of recommendation, sports reviews, etc.), background information (e.g., criminal history, medical history, etc.).

In another example, if the individual is a music teacher, information may be sought regarding, gender, age, areas of expertise (e.g., instruments, composition, etc.), reasons for joining the system (e.g., seeking employment, searching for talent, etc.), nature of education (e.g., formal training, self-taught, etc.), years of experience, ability to travel/relocate, previous employment (e.g., via a resume).

In yet another example, if the individual is an author, information may be sought regarding gender, age, past publications (e.g., including number, genre, publisher names, etc.), or the nature of works (e.g., plays, novels, movie scripts, etc.). In a further example, if the individual is a mere fan or spectator, information may be sought regarding general information about him/her, as well as any additional information the spectator chooses to provide. In an additional example, if the individual is an attorney or agent, information may be sought regarding education and professional backgrounds, and any associations (e.g., bar associations).

It should be noted, certain individuals may belong in multiple account types (e.g., a producer who owns his/her own production company). In this case, the individual must select which account types are appropriate for them and will then meet all the criteria necessary to activate their account. The account, once activated, may incorporate all of their information in one area, i.e., place all business affairs within their virtual “Tree Trunk.”

Also at step 650, where the entity comprises a non-individual, such entity may provide detailed information about itself. Generally, the purpose of creating business accounts based upon a unique set of questioning is to further promote, advertise, and/or solicit possible job opportunities for other individual entities. After a business (large or small) has been confirmed a as legitimate organization, such business may be issued a virtual “Seed.” A “Seed” certifies that the particular business, corporation, organization, etc., has met the criteria and approval of the system.

Once a “Seed” has been issued, the business may be requested to provide more additional and detailed information. In many embodiments this may be done in the form of an inquiry. Consider the examples of general questions: What kind of Business are you? What is the purpose of activating your “Springlinc Account?” What type(s) of service(s) does your company provide? How many years has your company been in existence? What are the standard requirements/qualifications needed by an applicant/prospect for submitting/recruiting for a job application? What skills and/or prior experience is needed to fulfill job requirements and tasks? Does employment with your company provide health insurance, sick pay, and/or other medical benefits? Does your company offer a pension program? Are there any opportunities for promotion within the company? Are the available job opportunities Part-time, Full-time or both? Are the available job opportunities temporary or long-term?

In addition to general questions, in certain embodiments, more specific questions may be asked of the business. For example, if the business comprises a talent agency, the following questions may be asked: What fields of entertainment does your company represent/promote? What are the general requirements expected of the talent holders/job applicants? What area/region does your company cover/in engaged in? Has your company discovered/manage any notable people (past and/or present)? In another example, if the business comprises a comedy club, the following questions may be asked: What kind of business are you? What is the purpose of activating your “Springlinc” Account? What kind of service(s) does your business provide? Where is your business located? How many years has your club been in existence?

In yet another example, if the business comprises a live entertainment company/club, the following questions may be asked: What type(s) of live entertainment does your club provide? What type of comedy does your club provide? Does your club offer compensation or is it just the exposure? Does your club offer “Open Mic” nights? In an additional example, if the business comprises a musical venue, the following questions may be asked: Does your club use a DJ, Live Band or both? What type of music does you club play?

In view of the above exemplary inquiries, many embodiments of the present invention require such level of detail because it will allow for downstream relationships to build on the proper foundation, particularly when networks become formed. For example: a business/talent seeker/coach will be narrowing down their search to what they specifically want; and entertainers from various fields will try to find establishments that are looking for their particular talents/services.

In further embodiments of the present invention, in order to avoid repetition, generally, all businesses will follow the same procedure of answering general questions followed by a list of specific questions relevant to the selected categories. Such information is important for various reasons (e.g., a unique idea with companies involving literary publications/works is the exclusive level of privacy between the sharing of works between writers (from all fields) and the publishing company, and as such, requisite information must be provided first).

At step 660, further detailed information may be provided and stored by the system. The optional information may include certain traits, qualifications, and skills and may comprise minute relevance regarding a search. For example, for an individual, a talent scout allowing the eye color of talent to be “optional.” In another example, for a business, a publishing house seeking new novelists enabling submission of novel types to be “optional.” In a further example, for educational institutions, an acting department seeking new actors whose backgrounds (stage/screen; dramatic/comedic, etc.) are all “Optional.”

At step 670, after all the requisite information is obtained from all entities, the system enables the ENC. Various types of ENC's may be formed within the system, as various entities in different areas of entertainment may form different types of synergistic relationships with other entities. In a first exemplary ENC, a network conglomerate may be formed around education. In one embodiment, educational facilities worldwide (Pre-School through College) seek to harness and promote the talents of their students. One goal of the system is to help schools throughout the world by promoting the school's strengths and making the school accessible/viewable to an international audience.

Generally speaking, such a platform will enable prospective students to locate the most suitable school for their specific needs, while permitting the school's “branches” (i.e., specific departments) to access a database of students/professionals qualified for enrollment or employment. In addition to the advantages, the system may also ensure the security of all students and teachers by requiring all educational facilities to confirm the legitimacy of the school through any number of security methods described above. While the above exemplary system is primarily directed towards education, embodiments of the present invention may clearly infiltrate any field of endeavor in the entertainment industry.

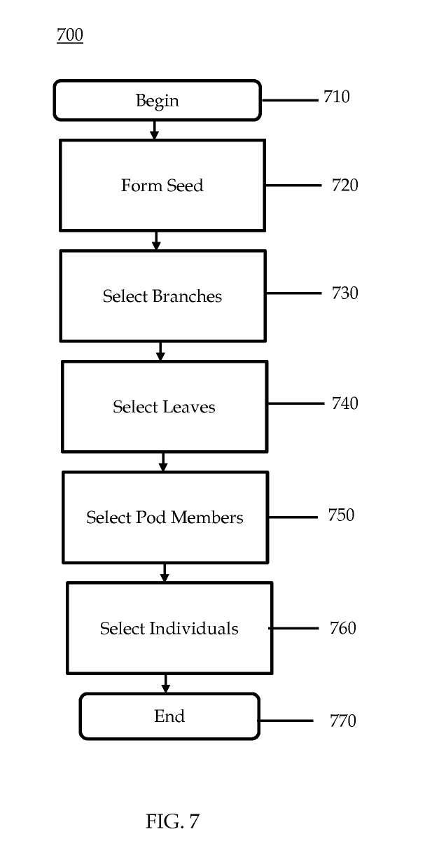

FIG. 7 depicts a flowchart of a method of creating an entertainment network conglomerate via a global computer network in accordance with exemplary embodiments of the present disclosure. In many embodiments, the way the educational “Springlinc” accounts will function within the system is based around a “branch” system coinciding with the “tree” system, as described herein. The method 700 may begin at step 710. At step 720, a school administrator may authorize the activation of a “Springlinc” Account, thus forming a “Seed.” The Springlinc account and the seed are generally described above with reference to FIGS. 1-5. In step 730, a school administrator may then select the departments to become the “branches,” to form the school's “tree,” i.e., their presence within the system. The tree and branches are generally described above with reference to FIGS. 1-5.

At step 740, once the “branches” have been selected, the administrator may then choose a representative from each department who will then become a “leaf” (i.e., a representative) of that respective department. As a “leaf,” the individual may assumes control/responsibility over the department and its affiliates of communicating with possible students and employees. Also, another responsibility of individuals in the “leaf” position will be to create, promote, update and edit their branch representing that specific department.

At step 750, a “branch” leader, or “leaf” may be provided specific questions regarding the requirements for each respective field of the acting department, and the system may receive those answers. For example, questions regarding GPA, portfolio work, and special skills will enable eligible students to find that particular school and for the school to view students who qualify for enrollment. Employment opportunities presented within the “branches” may follow the same pattern of questioning in order to find the most qualified candidates to fill the position(s) being offered. Entities that qualify for the criteria selected and/or entered by the leaves may be designated as pods, and may comprise a pool of individuals or other entities that may be presented to one or more leaves for selection.

At step 760, the system may be adapted to allow one or more leaves to select one or more of the pool of pods for acceptance. Acceptance may include acceptance into an educational institution, acceptance for an opportunity to interview for a position, acceptance to a job opening, acceptance to audition for an entertainment group, acceptance to become a member of an entertainment group, acceptance to perform at an event, and/or the like. After the specific pods are selected from the pool of pods, the method 700 generally ends at step 780.

While the foregoing is directed to exemplary embodiments of the present invention, other and further embodiments of the invention may be devised without departing from the basic scope thereof, and should be considered part of this disclosure, as if described fully herein. Specifically, whereas the worldwide web and mobile web are growing content and capabilities at ever-increasing rates, the ability to adapt the systems, methods, applications, and interfaces disclosed herein to existing or new mobile- or web-based technology is contemplated by embodiments of the present invention and does not depart the scope of the invention disclosed herein.

What is claimed is:

1. A computer-implemented method for creating a network conglomerate system, the method comprising:
at a computing device having one or more processors and memory storing one or more programs for execution by the one or more processors:
receiving a request to create a user account from an entity;
performing a security check to verify the identity of the entity;
allowing the entity to enter general information about the entity if the identity of the entity is verified;
receiving and storing the general information in a database and requesting specific information from the entity based on the general information entered by the entity;
receiving and storing the specific information in the database; and
enabling the network conglomerate system by generating and displaying a virtual tree based on the general information and the specific information, the tree comprising a virtual branch associated with at least one of a department and a skill.

2. The method of claim 1, wherein the entity comprises at least one of an individual, a business, an educational institution, and an entertainment group.

3. The method of claim 1, wherein the security check comprises at least one of manual entry of security data, confirmation of third party data, payment of a fee, visual identity confirmation, multi-factor authentication, and token authentication.

4. The method of claim 3, wherein the third party data comprises at least one of an employer identification number and a social security number.

5. The method of claim 3, wherein the third party data comprises at least one of a credit report and company profile from a commercial database.

6. The method of claim 1, wherein the general information comprises a purpose for requesting the user account, wherein the purpose may comprise at least one of employment, exposure, and searching for talent.

7. The method of claim 1, wherein the specific information comprises at least one of a profession, a talent, a skill, a gender, a physical characteristic, a language fluency, a residence address, an ethnicity, an education level, a listing of work experience, a disability indication, an indication of a willingness to travel, an indication of a willingness to relocate, a listing of published works, a profession subcategory, a type of training obtained, a position played, an instrument played, a number of years of experience, academic information, third party assessments, medical background information, financial background information, and criminal background information.

8. The method of claim 1, wherein the virtual tree further comprises virtual leaves associated with one or more branches, the leaves representing joint ventures the entity is associated with.

9. The method of claim 1, wherein the virtual tree further comprises virtual pods associated with one or more virtual branches, the virtual pods representing individual candidates that qualify for association with the one or more virtual branches based on information received from the candidates.

10. The method of claim 1, further comprising:
allowing the entity to search for at least one of an individual qualified for a position based upon information received from the individual and an organization having a position opening matching a set of qualifications received from an individual.

11. A computer-implemented method for creating a network conglomerate system, the method comprising:
at a computing device having one or more processors and memory storing one or more programs for execution by the one or more processors:
receiving a request to create a user account from an organization;
receiving information about the organization;
performing a security check to verify the identity of the organization;
issuing a virtual seed to the organization if the identity of the organization is verified and the information complies with a set of requirements, the seed comprising a certification the organization is approved to use the network conglomerate system;
generating a virtual trunk for the organization if a seed has been issued;
allowing the organization to add virtual branches to the virtual trunk, each of the virtual branches representing a department of the organization;
allowing the organization to add virtual leaves to the virtual branches, each of the virtual leaves associated with a representative of each department of the organization; and
generating and displaying a virtual tree, the virtual tree comprising the virtual trunk, the virtual branches, and the virtual leaves.

12. The method of claim 11, further comprising:
allowing the organization to add one or more virtual pods to the virtual branches, each of the virtual pods representing an individual qualified for a job opening based on information received from the individual.

13. The method of claim 12, wherein each of the leaves is granted access to set the requirements for pods; and
wherein each of the leaves is granted access to select a pod for inclusion on a branch.

14. The method of claim 11, wherein the security check comprises at least one of manual entry of security data, confirmation of third party data, payment of a fee, visual identity confirmation, multi-factor authentication, and token authentication.

15. The method of claim 11, wherein the information comprises at least one of a type of business, a purpose of activating a user account, a list of services provided, a business location, and a number of years in operation.

16. The method of claim 11, wherein the information comprises at least one of a field of entertainment, requirements of a job opening, a target geographic area, a list of notable clients, a type of organization, a type of live entertainment provided, a subcategory of a field of entertainment, a compensation structure, a listing of technological capabilities, a layout of a facility, a type of music played at a facility.

17. A computer-implemented method for creating a network conglomerate system, the method comprising:
at a computing device having one or more processors and memory storing one or more programs for execution by the one or more processors:
receiving a request to create a user account from an individual;
performing a security check to verify the identity of the individual;
allowing the individual to enter general information about the individual if the identity of the individual is verified;
receiving and storing the general information in a database and requesting specific information from the individual based on the general information;
receiving and storing the specific information in a database; and
enabling the network conglomerate system by generating and displaying a virtual tree based on the general information and the specific information, the tree comprising a virtual branch associated with a skill and leaves associated with one or more branches, the leaves representing joint ventures the individual is associated with.

18. The method of claim 17, wherein the general information comprises a purpose for requesting the user account, wherein the purpose may comprise at least one of employment, exposure, and searching for talent.

19. The method of claim 17, wherein the specific information comprises at least one of a profession, a talent, a skill, a gender, a physical characteristic, a language fluency, a residence address, an ethnicity, an education level, a listing of work experience, a disability indication, an indication of a willingness to travel, an indication of a willingness to relocate, a listing of published works, a profession subcategory, a type of training, a position played, an instrument played, a number of years of experience, academic information, third party assessments, medical background information, financial background information, and criminal background information.

20. The method of claim 17, further comprising:
allowing the individual to search for an organization having a position opening matching a set of qualifications of the individual.
